(19) United States
(12) Patent Application Publication
(10) Pub. No.: US 2018/0107503 A1
(43) Pub. Date: Apr. 19, 2018

(54) COMPUTER PROCUREMENT PREDICTING DEVICE, COMPUTER PROCUREMENT PREDICTING METHOD, AND RECORDING MEDIUM

(71) Applicants: NEC Corporation, Minato-ku, Tokyo (JP); NEC COMMUNICATION SYSTEMS, LTD., Minato-ku, Tokyo (JP)

(72) Inventors: Fumio MACHIDA, Tokyo (JP); Shunsuke KOHNO, Tokyo (JP); Masayuki NAKAGAWA, Tokyo (JP); Kosuke MAEBARA, Tokyo (JP)

(73) Assignee: NEC Corporation, Minato-ku, Tokyo (JP)

(21) Appl. No.: 15/568,821

(22) PCT Filed: Apr. 27, 2016
(86) PCT No.: PCT/JP2016/002210

§ 371 Date: Oct. 24, 2017

(30) Foreign Application Priority Data
May 7, 2015 (JP) 2015-094674

(51) Int. Cl. G06F 9/455; G06F 9/50

(52) U.S. Cl. CPC G06F 9/45558; G06F 2009/4557; G06F 9/50

(57) ABSTRACT

Provided is a computer-procurement-timing predicting device to properly predict a timing at which an additional computer on which a VM is to be placed is required, by considering a demand fluctuation, re-placement of a computational period, and a load fluctuation of the VM. The device includes: a VM-demand predicting module which calculates, based on demand fluctuation statistics which indicate a generation status of a virtual machine (hereinafter, a VM) to be deployed on a plurality of computers, a predicted value of a number of the VMs which are generated from a time t−Δt to a time t, and adds the predicted value to a placement target list which registers a number of the VMs deployed on the computers at the time t−Δt; a VM-load-fluctuation predicting module which outputs, based on load fluctuation statistics which indicate a load fluctuation of the VM on the plurality of the computers, a predicted load at the time t of each of the VMs, the number of which is registered in the placement target list; and a VM-placement-control virtually-executing module which virtually places, based on the predicted load, the VMs, the number of which is registered in the placement target list, on the plurality of the computers at the time t, and determines whether or not a resource shortage occurs.

### TECHNICAL FIELD

The present invention relates to a computer procurement predicting device, a computer procurement predicting method, and a program. The present invention particularly relates to a device, a method, and a program, which predict a timing to add a computer on which a virtual machine is to be placed, by considering demand prediction and load fluctuation of a virtual machine in, for example, a cloud environment.

### BACKGROUND ART

A private cloud system, which provides computer resources aggregated in a data center for a user in an organization via a network, is widely utilized. In recent years, the private cloud system has also been used for a purpose of avoiding a risk of information leakage associated with a loss or the like of a mobile terminal, by executing, in the private cloud system, computational processing of a smartphone, a tablet terminal, and the like. A user does not store secret information in a mobile terminal, but instead accesses an execution environment in a data center via a virtual private network, so that a secure and efficient mobile working environment can be realized.

In the data center in the private cloud system, a virtual machine (hereinafter, a VM) is generally utilized for executing computational processing. The VM is a virtual computer environment realized by software. The VM makes it possible to effectively utilize a physical server computer resource, since a plurality of VMs can be executed simultaneously on a physical server. Moreover, the VM once created can also be moved to another physical server. An operator of the private cloud system can utilize the computer resource in the data center as effectively as possible, by operating the data center while changing placement of the VM. To optimize placement of the VM, various technologies of VM placement designing are utilized. By devising how to place the VM, the operator of the private cloud system can run as many virtual machines as possible on a restricted physical server.

However, when a demand for the VM is continuously increasing as a number of users of the private cloud system increases, server aggregation intended by the VM placement designing reaches a limit, thereby causing a shortage of the computer resource in the data center. When facing the shortage of the computer resource, the operator of the private cloud system is required to newly add a physical server, to thereby assure a computer resource that meets the demand. To add a physical server, however, cost for procuring a new server is required. Further, cost required for disposing the physical server, changing a system configuration, reviewing an operating procedure, and the like is not negligible. From such a viewpoint, the operator of the private cloud system desirably predicts in advance a timing at which an additional physical server is needed.

Foreseeing a demand and procuring a product or a component in advance has been widely known as an inventory management problem. For example, PTL 1 discloses a demand predicting device that calculates a required intermediate component, based on a sales track record of a product, and concurrently calculates a number of required components, based on data about a utilization track record of the components.

PTL 2 discloses an example of a technique of determining a timing to add a server by predicting a load fluctuation of an application that operates in a computer. Based on a premise that the load fluctuation of the application is predicted, PTL 2 discloses a technique of reducing a risk in a case where the prediction is wrong.

A number of VMs that can operate on a physical server varies depending on a type, an amount, and a load fluctuation of a computer resource that each VM utilizes. A VM no longer utilized requires no computer resource. Further, by considering such a characteristic of the VM, a VM placement designing function operates to determine placement of the VM, so as to utilize the computer resource in the physical server as effectively as possible. For example, NPL 1 discloses a technology of monitoring a load fluctuation of a VM, flexibly changing placement of the VM on a physical server, and distributing a load.

PTL 3 discloses a system that grasps a period during which the system requires a jumping server, based on demand prediction data on the system. PTL 4 discloses a system that monitors a number of subscribers that a session initiation protocol (SIP) server on a virtual machine processes, and estimates an amount of traffic expected to occur subsequently. When an amount of processing of physical hardware on which a virtual machine runs exceeds an optimal value, this system migrates the virtual machine to other physical hardware.

PTL 5 discloses a system that acquires, from each virtual server, a CPU use rate, a memory use rate, an input/output performance value of a recording medium, an input/output performance value of a communication control device, and the like, as resource information. This system determines, from the acquired resource amount, resource amounts of virtual servers, respectively, which satisfy a required amount of processing performance. PTL 6 discloses a device that acquires a virtual machine activation history for each combination of types and levels of priority of virtual machines.

### CITATION LIST

### Patent Literature

### [PTL 1]

Japanese Patent No. 4242574

### [PTL 2]

Japanese Patent No. 5077617

### [PTL 3]

International Publication No. WO2008/041302

### [PTL 4]

International Publication No. WO2013/038585

### [PTL 5]

International Publication No. WO2011/043011

### [PTL 6]

Japanese Unexamined Patent Application Publication No. 2014-164434

### Non Patent Literature

### [NPL 1]

T. Wood, P. Shenoy, A. Venkataramani, M. Yousif, Sandpiper: Black-box and gray-box resource management for virtual machines, Computer Networks, Vol. 53, No. 17, pp. 2923 to 2038, 2009.

### SUMMARY OF INVENTION

### Technical Problem

The inventory management method as disclosed in PTL 1 cannot be applied directly to the physical server demand prediction in the private cloud system. This is because, although the physical server is influenced by a demand for the VM, a number of demanded VMs is not directly related to a number of required physical servers. The VM is not homogeneous like a component, but requires a different amount of a computer resource and bears a different load depending on a user's utilization tendency. For the server demand prediction, it is also necessary to consider a load fluctuation of the VM.

The scheme of predicting a server demand as disclosed in PTL 2 aims to predict a timing at which an additional server is required, based on a demand for a server itself or on a load fluctuation. In a server procurement problem in the private cloud environment, the VM that is a unit of demand differs from a physical server that is a unit of computer resource. Accordingly, this prediction scheme cannot be simply applied.

NPL 1 does not disclose a technology of predicting a timing to procure a physical server.

The technologies disclosed in PTLs 3 to 6 also have a problem similar to the problem described above.

As such, it has been difficult so far to predict a timing to procure a server under a private cloud environment, that may be influenced by a characteristic of the VM, and an operation of the VM placement designing function.

A first problem is that a timing at which an additional physical server is required cannot be predicted accurately based only on VM demand prediction. This is because a load on the VM that operates on a physical server varies with lapse of time, and a VM no longer used requires no resource in the physical server.

A second problem is that such a VM placement technology that flexibly changes a physical server to operate the VM, depending on a load fluctuation of the VM, makes it difficult to accurately predict a timing at which an additional physical server is required. This is because a number of physical servers required for aggregating VMs differs depending on an algorithm or a scheme that performs re-placement.

An object of the present invention is to provide a computer-procurement-timing predicting device that can solve a problem of being unable to accurately predict a timing at which an additional physical server is required. This problem is caused by the demand fluctuation and the load fluctuation of the virtual machine, as mentioned above.

Another object of the present invention is to provide a server-procurement-timing predicting device that can solve another problem of being unable to accurately predict a timing at which an additional physical server is required. This problem is caused by the operation of the VM placement technology that re-places the virtual machine, as mentioned above.

### Solution to Problem

One aspect of the present invention is a computer-procurement-timing predicting device. The device includes: a VM-demand predicting module which calculates, based on demand fluctuation statistics which indicate a generation status of a virtual machine (hereinafter, a VM) to be deployed on a plurality of computers, a predicted value of a number of the VMs which are generated from a time t−Δt to a time t, and adds the predicted value to a placement target list which registers a number of the VMs deployed on the computers at the time t−Δt; a VM-load-fluctuation predicting module which outputs, based on load fluctuation statistics which indicate a load fluctuation of the VM on the plurality of the computers, a predicted load at the time t of each of the VMs, the number of which is registered in the placement target list; and a VM-placement-control virtually-executing module which virtually places, based on the predicted load, the VMs, the number of which is registered in the placement target list, on the plurality of the computers at the time t, and determines whether or not a resource shortage occurs.

One aspect of the present invention is a computer-procurement-timing predicting method. The method includes: calculating, based on demand fluctuation statistics which indicate a generation status of a virtual machine (hereinafter, a VM) to be deployed on a plurality of computers, a predicted value of a number of the VMs which are generated from a time t−Δt to a time t, and adding the predicted value to a placement target list which registers a number of the VMs deployed on the computers at the time t−Δ; outputting, based on load fluctuation statistics which indicate a load fluctuation of the VM on the plurality of the computers, a predicted load at the time t of each of the VMs, the number of which is registered in the placement target list; and virtually placing, based on the predicted load, the VMs, the number of which is registered in the placement target list, on the plurality of the computers at the time t, and determining whether or not a resource shortage occurs.

### Advantageous Effects of Invention

A control device according to the present invention can properly predict a timing at which an additional computer on which a VM is to be placed is required, by considering a demand fluctuation, re-placement of a computational period, and a load fluctuation of the VM.

### BRIEF DESCRIPTION OF DRAWINGS

FIG. 1 is a block diagram of a computer-procurement-timing predicting device 100 according to a first example embodiment of the present invention;

FIG. 2 is a block diagram illustrating a detailed configuration of a VM-demand predicting unit 103;

FIG. 3 is a block diagram illustrating a detailed configuration of a VM-load-fluctuation predicting unit 104;

FIG. 4 is a flowchart of a whole operation of the computer-procurement-timing predicting device 100 according to the present example embodiment;

FIG. 5 is a flowchart of an operation of the VM-demand predicting unit 103;

FIG. 6 is a flowchart of an operation of the VM-load-fluctuation predicting unit 104;

FIG. 7 illustrates an example of a transition matrix of a discrete-time Markov chain model;

FIG. 8 is a block diagram of a computer-procurement-timing predicting system 300 according to a second example embodiment of the present invention;

FIG. 9 is a block diagram of a computer-procurement-timing predicting device 100 according to a third example embodiment of the present invention;

FIG. 10 is a flowchart of an operation of a VM-load-fluctuation-pattern generating unit 113;

FIG. 11 illustrates an example of a load fluctuation pattern and a model that represents its state transition;

FIG. 12 is a block diagram of a computer-procurement-timing predicting device 100 according to a fourth example embodiment of the present invention;

FIG. 13 is a flowchart of a whole operation of the computer-procurement-timing predicting device 100 according to the present example embodiment; and

FIG. 14 is a block diagram of a computer-procurement-timing predicting device 100 according to a fifth example embodiment of the present invention.

### DESCRIPTION OF EMBODIMENTS

### First Example Embodiment

### [Configuration]

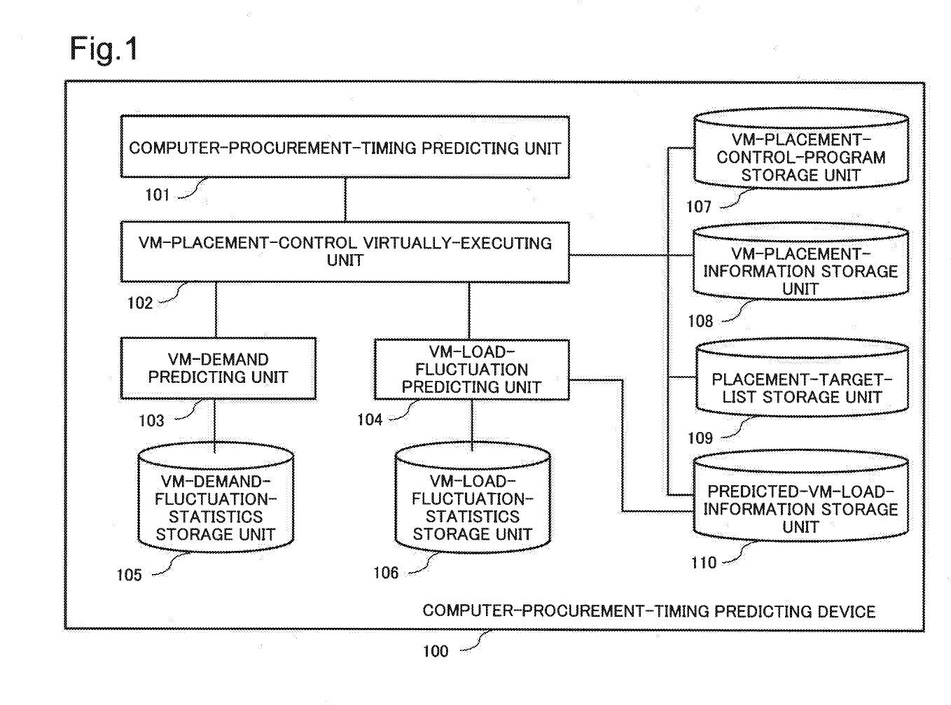

FIG. 1 is a block diagram of a computer-procurement-timing predicting device 100 according to a first example embodiment of the present invention. The computer-procurement-timing predicting device 100 predicts a timing at which a shortage of a resource in a computer (hereinafter, a VM host) that executes a VM occurs owing to a load increase. A plurality of VM hosts are placed in, for example, a data center.

The computer-procurement-timing predicting device 100 predicts the load increase by predicting two items of an increase in number of VMs that are placed, and an increase in load of each of the VMs. The computer-procurement-timing predicting device 100 then virtually places VMs, the number and load of which have been predicted, in other words, performs a placement simulation, to predict a timing at which a resource shortage occurs.

The computer-procurement-timing predicting device 100 in the present example embodiment includes a computer-procurement-timing predicting unit 101, a VM-placement-control virtually-executing unit 102, a VM-demand predicting unit 103, and a VM-load-fluctuation predicting unit 104. Further, the computer-procurement-timing predicting device 100 includes a VM-demand-fluctuation-statistics storage unit 105, a VM-load-fluctuation-statistics storage unit 106, a VM-placement-control-program storage unit 107, a VM-placement-information storage unit 108, a placement-target-list storage unit 109, and a predicted-VM-load-information storage unit 110.

The VM-demand predicting unit 103 predicts a number of the VMs that are newly generated during a certain future time period Δt, from demand fluctuation statistics. The demand fluctuation statistics are statistical information that includes a VM generating status on the VM host, for example, a time string, at each time of which a new VM is generated. The demand fluctuation statistics are acquired on each VM host, for example, and are collectively stored in the VM-demand-fluctuation-statistics storage unit 105. The VM-demand predicting unit 103 adds a predicted value to a placement list in the placement-target-list storage unit 109.

The VM-load-fluctuation predicting unit 104 predicts a loaded state at a certain future time t of each VM, from load fluctuation statistics. The load fluctuation statistics are statistical information that includes load information statistics on each VM in the VM host, for example, a history of a processor use time and a memory use amount in each VM. The load information statistics are acquired on each VM host, for example, and are collectively stored in the VM-load-fluctuation-statistics storage unit 106. The VM-load-fluctuation predicting unit 104 stores the predicted load information in the predicted-VM-load-information storage unit 110.

The VM-placement-control virtually-executing unit 102 virtually deploys the VM on the VM host, based on a number of the VMs currently placed on the VM host, a predicted number of the VMs that are newly generated, and a predicted load on each VM. The VM-placement-control virtually-executing unit 102 then checks whether the VM host has a sufficient resource. Further, the VM-placement-control virtually-executing unit 102 performs this check at a plurality of time points, for example, at a fixed time interval, while successively incrementing a virtual timer. When detecting a time at which a resource shortage occurs, the VM-placement-control virtually-executing unit 102 outputs the time thus detected.

The VM-placement-control virtually-executing unit 102 obtains, for example, the number of the VMs currently placed on the VM host, and a resource amount the VM host has, from the VM-placement-information storage unit 108. Moreover, the VM-placement-control virtually-executing unit 102 activates a VM placement control program stored in the VM-placement-control-program storage unit 107 to execute virtual placement of the VM. Notably, the VM-placement-control virtually-executing unit 102 may contain an algorithm of the VM placement control program in advance.

The computer-procurement-timing predicting unit 101 sets an operating environment of, controls an operation of, and displays an output value of, each of the units mentioned above.

Notably, the time is an index that can identify a time point over years, months, and days.

The computer-procurement-timing predicting unit 101, the VM-placement-control virtually-executing unit 102, the VM-demand predicting unit 103, and the VM-load-fluctuation predicting unit 104 are each configured with a logic circuit. The computer-procurement-timing predicting unit 101, the VM-placement-control virtually-executing unit 102, the VM-demand predicting unit 103, and the VM-load-fluctuation predicting unit 104 each may also be implemented as a program. In this case, the program is stored in a memory (not illustrated) in the computer-procurement-timing predicting device 100, which also serves as a computer, and is executed by a processor (not illustrated) in the computer-procurement-timing predicting device 100.

Each of the VM-demand-fluctuation-statistics storage unit 105, the VM-load-fluctuation-statistics storage unit 106, the VM-placement-control-program storage unit 107, the VM-placement-information storage unit 108, the placement-target-list storage unit 109, and the predicted-VM-load-information storage unit 110 is a storage device such as a semiconductor memory and a disk device.

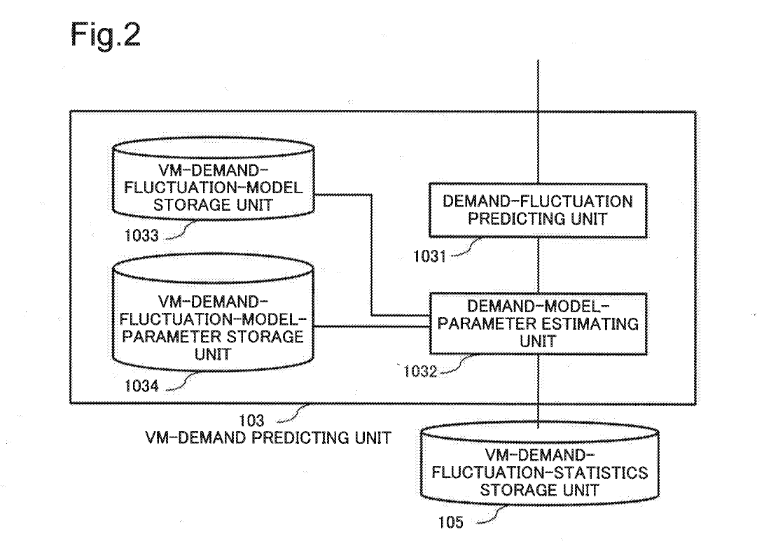

FIG. 2 is a block diagram illustrating a detailed configuration of the VM-demand predicting unit 103. The VM-demand predicting unit 103 includes a demand-fluctuation predicting unit 1031, a demand-model-parameter estimating unit 1032, a VM-demand-fluctuation-model storage unit 1033, and a VM-demand-fluctuation-model-parameter storage unit 1034.

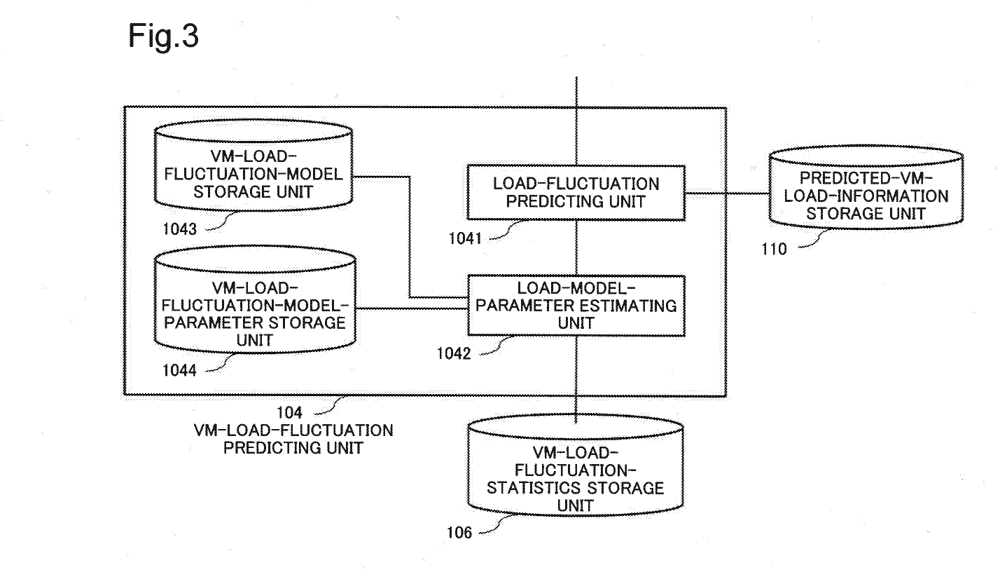

FIG. 3 is a block diagram illustrating a detailed configuration of the VM-load-fluctuation predicting unit 104. The VM-load-fluctuation predicting unit 104 includes a load-fluctuation predicting unit 1041, a load-model-parameter estimating unit 1042, a VM-load-fluctuation-model storage unit 1043, and a VM-load-fluctuation-model-parameter storage unit 1044.

### [Operation]

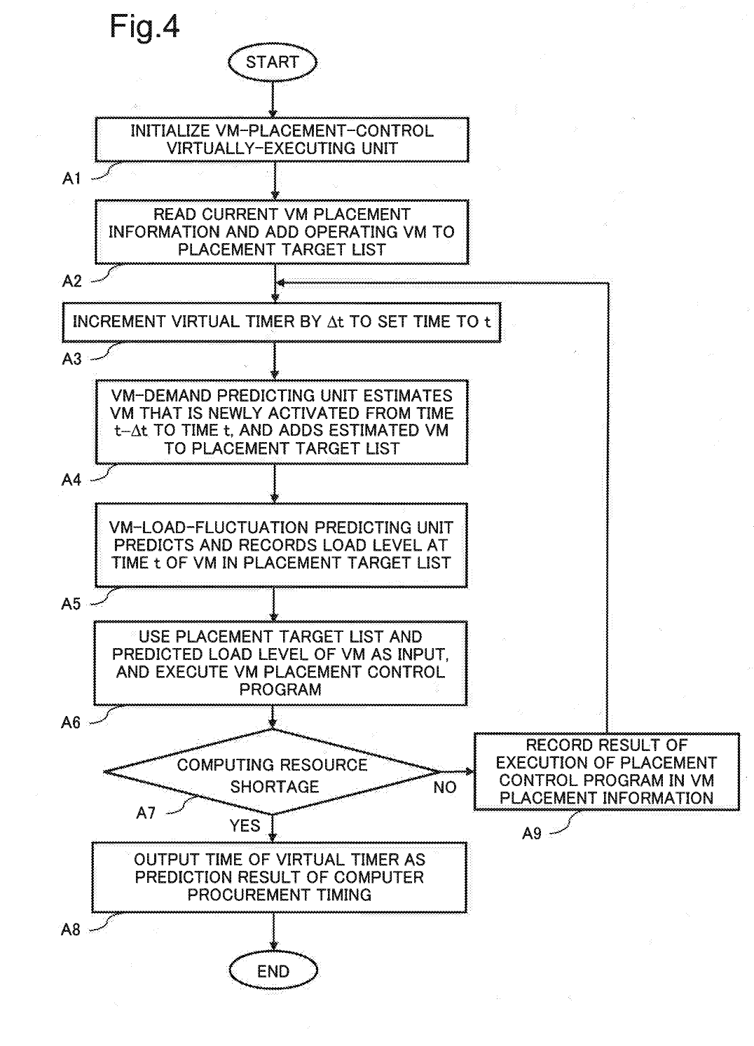

FIG. 4 is a flowchart of a whole operation of the computer-procurement-timing predicting device 100 according to the present example embodiment.

Initially, the computer-procurement-timing predicting unit 101 sets the VM-placement-control virtually-executing unit 102 to an initial state (step A1 in FIG. 4). Here, the computer-procurement-timing predicting unit 101 resets internal state information required for virtually executing VM placement control, and reads a program or an initial value required for the virtual execution, for example.

Next, the VM-placement-control virtually-executing unit 102 refers to the VM-placement-information storage unit 108 to refer to current VM placement information. The VM-placement-control virtually-executing unit 102 then extracts the VM that is a placement target, and records the VM in the placement target list in the placement-target-list storage unit 109 (step A2). Here, the list of the extracted VMs is, for example, a list of an identifier and an attribute of each of the VMs. The VM-placement-control virtually-executing unit 102 may only extract a number of the VMs and record the extracted number in the placement target list. Further, the VM-placement-control virtually-executing unit 102 may acquire a loaded state of each VM from the current VM placement information, and may store the loaded state in the predicted-VM-load-information storage unit 110.

The VM-placement-control virtually-executing unit 102 increments a time of the virtual timer by Δt and sets a virtual time to t, in order to virtually execute the VM placement control (step A3). Notably, an initial value of the virtual timer is set to t−Δ. This value represents a time for starting prediction, namely, a time at which the VM-placement-control virtually-executing unit 102 is activated.

Next, the VM-placement-control virtually-executing unit 102 calls up the VM-demand predicting unit 103. The VM-demand predicting unit 103 estimates a number of the VMs that are newly activated from the time t−Δt to the time t, and adds the estimated number to the placement target list (step A4). Here, the VM-demand predicting unit 103 may estimate an attribute or an initial loaded state of the VM that is activated.

Further, the VM-placement-control virtually-executing unit 102 calls up the VM-load-fluctuation predicting unit 104. The VM-load-fluctuation predicting unit 104 predicts a load level at the time t for each VM recorded in the placement target list, and stores the predicted load level in the predicted-VM-load-information storage unit 110 (step A5).

The VM-placement-control virtually-executing unit 102 uses the placement target list and the predicted load level of each VM, as an input, to perform loading and execution of the VM placement control program stored in the VM-placement-control-program storage unit 107 (step A6). Here, a load on each VM is given by a use amount of each resource, for example, a processor use time and a memory use amount. On the other hand, recorded in the VM-placement-information storage unit 108 is the resource amount in each VM host. The VM placement control program compares a sum of the loads on the VMs with the resource amount in each VM host, for each resource, for example, and virtually places the VM recorded in the placement target list on any of the VMs. The VM placement control program checks whether all of the VMs can be placed on any of the VM hosts.

In this virtual placement, it is important to determine which VM being placed on which VM host enables the VMs to be used with high resource efficiency as a whole. This problem is known as a problem of dynamic VM re-placement. The VM placement control program may use any of known and unknown techniques to perform the dynamic VM re-placement.

As a result of the execution of the VM placement control program, when it is revealed that the VM host faces a resource shortage (YES at step A7), the VM-placement-control virtually-executing unit 102 outputs the time t of the virtual timer as a prediction result of a server procurement timing (step A8).

When all of the VMs recorded in the placement target list can be placed on the VM host (NO at step A7), the VM-placement-control virtually-executing unit 102 records VM placement information in the VM-placement-information storage unit 108 (step A9). The VM placement information is a result of the execution of the VM placement control program. Subsequently, the VM-placement-control virtually-executing unit 102 further increments the time of the virtual timer by Δt (step A3), and repeats the prediction and the determination described above, until a shortage of the computer resource occurs (YES at step A7).

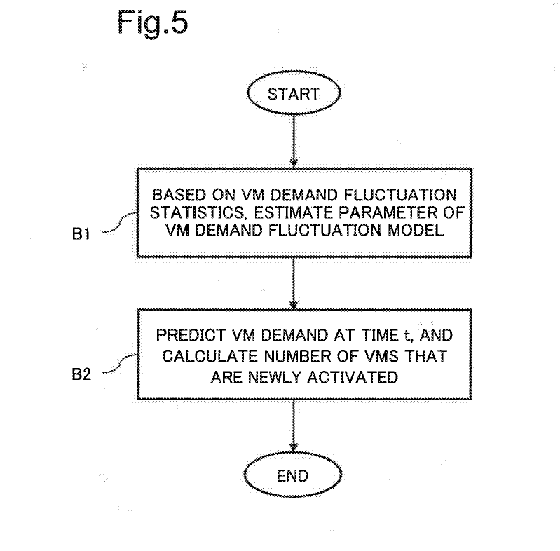

FIG. 5 is a flowchart of an operation of the VM-demand predicting unit 103.

The VM-demand predicting unit 103 uses the demand-model-parameter estimating unit 1032 to estimate a parameter value of a VM demand model based on VM demand fluctuation statistical information (step B1). The VM demand model is stored in the VM-demand-fluctuation-model storage unit 1033. For example, when the VM demand model is a Poisson arrival process model, a parameter of the model is an average arrival rate λ of a VM generation request. The VM-demand predicting unit 103 uses a number N of VM utilization requests that have arrived during a period T to determine an estimated value of the average arrival rate λ as N/T. N and T are obtained from information on a past VM demand fluctuation.

Moreover, the VM-demand predicting unit 103 may use a time series analysis model as the VM demand model. The time series analysis model captures a fluctuation in VM utilization request per past unit time, as time series data. The time series analysis model is, for example, an autoregressive model (Autoregressive), a moving-average model (Moving Average), an autoregressive integrated moving-average model, or a seasonal autoregressive moving-average model. The VM-demand predicting unit 103 may use a general technique such as a maximum likelihood method, as a method of estimating the parameter.

Next, the VM-demand predicting unit 103 uses the demand-fluctuation predicting unit 1031 to estimate a number of the VM utilization requests that arrives during the period Δt, from the VM demand fluctuation model. As for the VM demand fluctuation model, its parameter value has been determined. The VM-demand predicting unit 103 then outputs the estimated number as the number of the VMs that are newly generated (step B1). For example, when a Poisson arrival model is given, the VM-demand predicting unit 103 determines the number of the requests that arrives by λΔt. Moreover, when a time series model M is given, the VM-demand predicting unit 103 determines the number of the requests that arrives by integrating a value of M in a section of Δt.

At this time, the VM-demand predicting unit 103 may estimate a VM's attribute and a VM's load at its generation. The VM-demand predicting unit 103 estimates the VM's attribute and the VM's load at its generation from, for example, an option determined based on a statistical value acquired on the VM host, and an occurrence probability of the option.

Notably, the parameter estimation at step B1 may be executed in advance in another computer or the like, and an estimated value may be given to the VM-demand predicting unit 103.

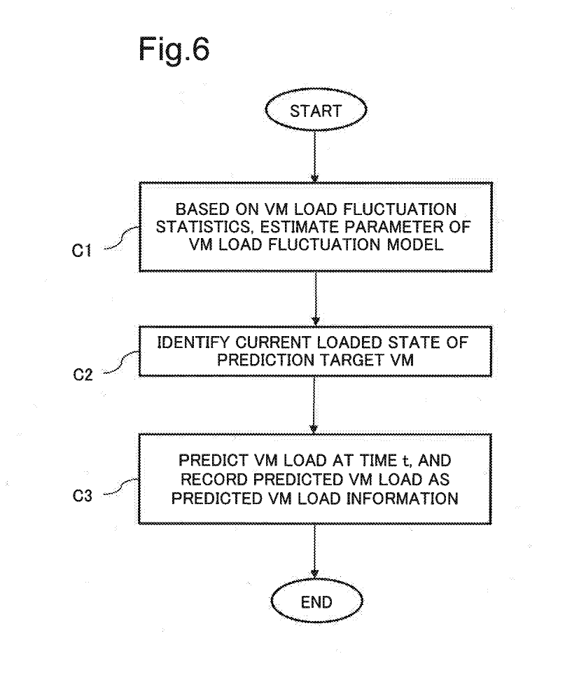

FIG. 6 is a flowchart of an operation of the VM-load-fluctuation predicting unit 104.

The VM-load-fluctuation predicting unit 104 uses the load-model-parameter estimating unit 1042 to estimate a parameter value of a load fluctuation model, based on VM load fluctuation statistical information (step C1). The load fluctuation model is stored in the VM-load-fluctuation-model storage unit 1043. For example, when a discrete-time Markov chain model is used as the VM load fluctuation model, the VM-load-fluctuation predicting unit 104 determines a probability of a transition from one loaded state to another loaded state for each time period Δt, as a parameter value. For example, it is assumed that a loaded state of the VM is defined by a set of a loaded state of a CPU and a loaded state of a memory, and each of the loaded states of the CPU and the memory is represented by any of index values of low, intermediate, and high. At this time, given to the VM-load-fluctuation predicting unit 104 is the discrete-time Markov chain model in which a transition of a loaded state of the system consists of nine different states.

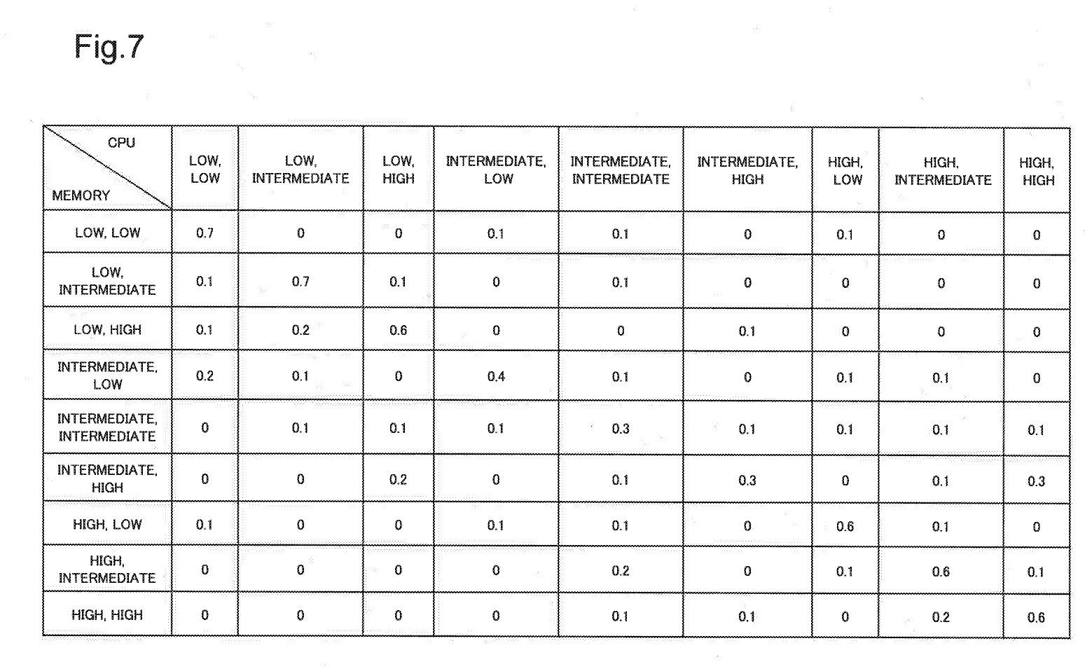

FIG. 7 illustrates an example of a transition matrix of the discrete-time Markov chain model. Each row represents a pre-transition state, and each column represents a post-transition state. A value of the matrix represents a transition probability. For example, a probability of a transition from a state (low, low) to a state (intermediate, low) during Δt is 0.1. The VM-load-fluctuation predicting unit 104 refers to the VM load fluctuation statistical information, for example, to trace a past history, and estimates such a transition probability. For example, a case is assumed where the state (low, low) occurs 100 times, among which the state (low, low) still occurs 70 times even after Δt. In such a case, the VM-load-fluctuation predicting unit 104 estimates that a transition probability from the state (low, low) to the state (low, low) is 0.7.

Notably, the loaded state of the discrete-time Markov chain model, which is given to the VM-load-fluctuation predicting unit 104, is not necessarily defined by a load on the CPU and a load on the memory. The loaded state may be defined by, for example, four resource loads including a disk capacity and a communication capacity, in addition to the loads on the CPU and the memory, or may be defined by much more resource loads. Further, the value of the index that represents the load may not be a value of three levels such as high, intermediate, and low, but may be a value of much more levels. Moreover, the load fluctuation model given to the VM-load-fluctuation predicting unit 104 may be a model that predicts a next loaded state based on a series of past fluctuations.

The VM-load-fluctuation predicting unit 104 uses the load-fluctuation predicting unit 1041 to refer to the placement target VM list given by the VM-placement-control virtually-executing unit 102, and to the predicted-VM-load-information storage unit 110. The VM-load-fluctuation predicting unit 104 then identifies a current loaded state (a loaded state at the time t−Δt) of the placement target VM (step C2). An initial value of the predicted-VM-load-information storage unit 110 is a loaded state of each VM at the time for starting the prediction.

Next, the VM-load-fluctuation predicting unit 104 uses the load-fluctuation predicting unit 1041 to estimate a loaded state at the time t, with use of the VM load fluctuation model, a parameter value of which has been determined. The VM-load-fluctuation predicting unit 104 then stores the estimated loaded state in the predicted-VM-load-information storage unit 110 (step C3). Notably, as load information on a newly generated VM, the VM-load-fluctuation predicting unit 104 may use an estimated value outputted by the VM-demand predicting unit 103, may use a fixed value given as a parameter, or may randomly select any from some options.

In an example of the discrete-time Markov chain model, the VM-load-fluctuation predicting unit 104 determines a transition state based on a probability specified by the transition probability. For example, based on the transition probability in FIG. 7, the VM that is in the state (low, low) at the time t−Δt transitions, at the time t, to any of the state (low, low), the state (intermediate, low), a state (intermediate, intermediate), and a state (high, low).

Moreover, the parameter (transition probability) estimation at step C1 may be executed in advance in another computer or the like, and an estimated value may be given to the VM-load-fluctuation predicting unit 104.

### [Effects]

The computer-procurement-timing predicting device 100 in the present example embodiment can properly predict the timing at which an additional VM host is required, by considering the demand fluctuation and the load fluctuation of the VM, and the algorithm that re-places the VM. This is because the VM-demand predicting unit 103 predicts the VM that is added, the VM-load-fluctuation predicting unit 104 predicts a load fluctuation of the VM during operation and a load fluctuation of the VM that is newly added, and the VM-placement-control virtually-executing unit 102 uses the VM re-placement algorithm to virtually execute the VM placement control.

### Second Example Embodiment

### [Configuration]

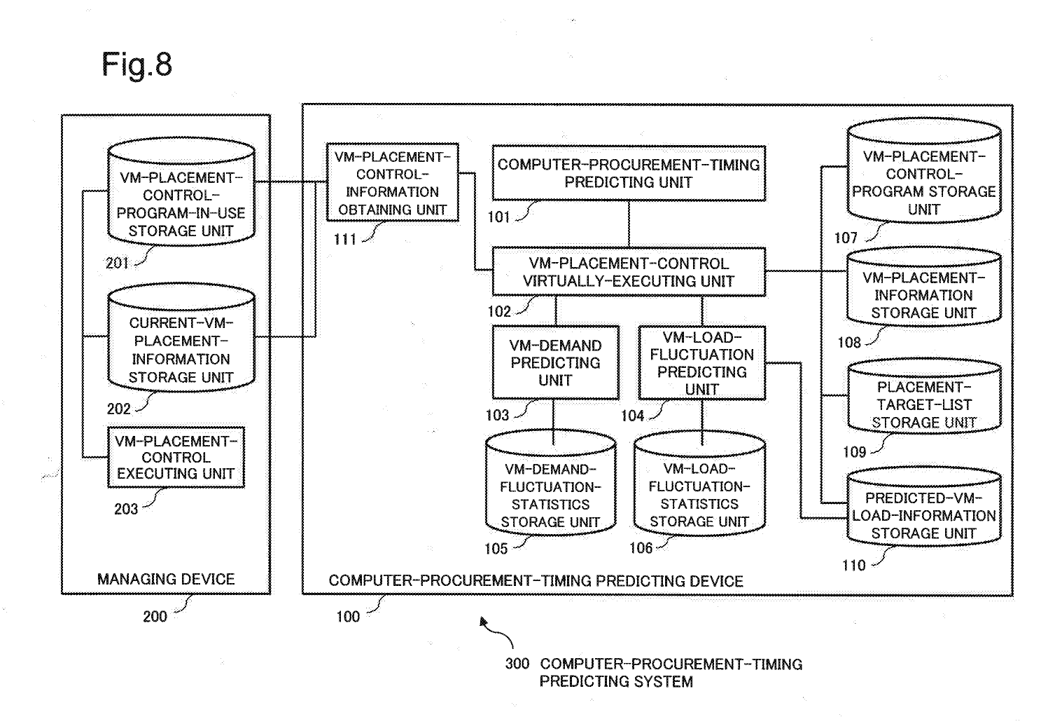

FIG. 8 is a block diagram of a computer-procurement-timing predicting system 300 according to a second example embodiment of the present invention. The computer-procurement-timing predicting system 300 includes a computer-procurement-timing predicting device 100 and a managing device 200. The managing device 200 is a device that actually controls VM placement in the data center in the private cloud system. The managing device 200 is connected to the VM host in the data center.

In comparison with the computer-procurement-timing predicting device 100 according to the first example embodiment, the computer-procurement-timing predicting device 100 in the present example embodiment further includes a VM-placement-control-information obtaining unit 111. The managing device 200 includes a VM-placement-control-program-in-use storage unit 201, a current-VM-placement-information storage unit 202, and a VM-placement-control executing unit 203.

The VM-placement-control-information obtaining unit 111 acquires, from the managing device 200, a VM placement control program stored in the VM-placement-control-program-in-use storage unit 201. Further, the VM-placement-control-information obtaining unit 111 acquires the current VM placement information stored in the current-VM-placement-information storage unit 202 in the managing device 200. The current VM placement information includes the number of the VMs currently placed on the VM host, and the resource amount each VM host has. The current VM placement information may also include an identifier, an attribute, and a current load of each of the VMs currently placed on the VM host.

The VM-placement-control executing unit 203 applies the VM placement control program stored in the VM-placement-control-program-in-use storage unit 201 to the current VM placement information, to output a placement plan. According to the output, the VM-placement-control executing unit 203 then actually executes placement of the VM on the VM host in the data center.

The VM-placement-control-information obtaining unit 111 is configured with a logic circuit. The VM-placement-control-information obtaining unit 111 may be implemented as a program. In this case, the program is stored in a memory (not illustrated) in the computer-procurement-timing predicting device 100, which also serves as a computer, and is executed by a processor (not illustrated) in the computer-procurement-timing predicting device 100.

### [Operation]

An operation of the computer-procurement-timing predicting device 100 in the present example embodiment also coincides with the operation illustrated by the flowchart in FIG. 4 in many respects. A difference therebetween is as follows.

The computer-procurement-timing predicting unit 101 sets the VM-placement-control virtually-executing unit 102 to an initial state (step A1 in FIG. 4). At this time, the VM-placement-control-information obtaining unit 111 is activated to acquire a VM placement control program in use saved in the VM-placement-control-program-in-use storage unit 201 in the managing device 200. The VM-placement-control-information obtaining unit 111 then stores the acquired VM placement control program in use, in the VM-placement-control-program storage unit 107 in the computer-procurement-timing predicting device 100. Further, the VM-placement-control-information obtaining unit 111 acquires the current VM placement information saved in the current-VM-placement-information storage unit 202 in the managing device 200. The VM-placement-control-information obtaining unit 111 then stores the acquired current VM placement information, in the VM-placement-information storage unit 108 in the computer-procurement-timing predicting device 100.

Subsequent processing is to the same as that in the computer-procurement-timing predicting device 100 according to the first example embodiment. Notably, there may be a case where the VM-placement-control virtually-executing unit 102 is configured with a logic circuit, for example, and contains in advance some algorithms of the VM placement control program. In this case, the VM-placement-control-information obtaining unit 111 may acquire algorithm selection information, or a parameter of each of the algorithms, instead of acquiring the VM placement control program from the managing device 200.

### [Effects]

The computer-procurement-timing predicting device 100 in the present example embodiment can adequately predict the timing at which an additional VM host is required, based on a VM re-placing operation actually performed in the data center. This is because the VM-placement-control-information obtaining unit 111 acquires the VM placement control program actually utilized for the placement control in the data center, and the current VM placement information in the data center, from the managing device 200. Based on the acquired VM placement control program and the acquired current VM placement information, the VM-placement-control virtually-executing unit 102 virtually then executes the VM placement control.

Accordingly, the computer-procurement-timing predicting device 100 in the present example embodiment can predict a proper server procurement timing adaptively to a latest state, even when the VM placement control program utilized in the managing device 200 or the VM placement on the VM host changes.

Notably, when the VM-placement-control virtually-executing unit 102 does not use the VM placement control program, the VM-placement-control-information obtaining unit 111 acquires a parameter that relates to a VM placement control algorithm, from the managing device 200. The VM-placement-control virtually-executing unit 102 virtually executes the VM placement control based on the acquired information, and accordingly, effects similar to those in the case of using the VM placement control program are expected.

### Third Example Embodiment

### [Configuration]

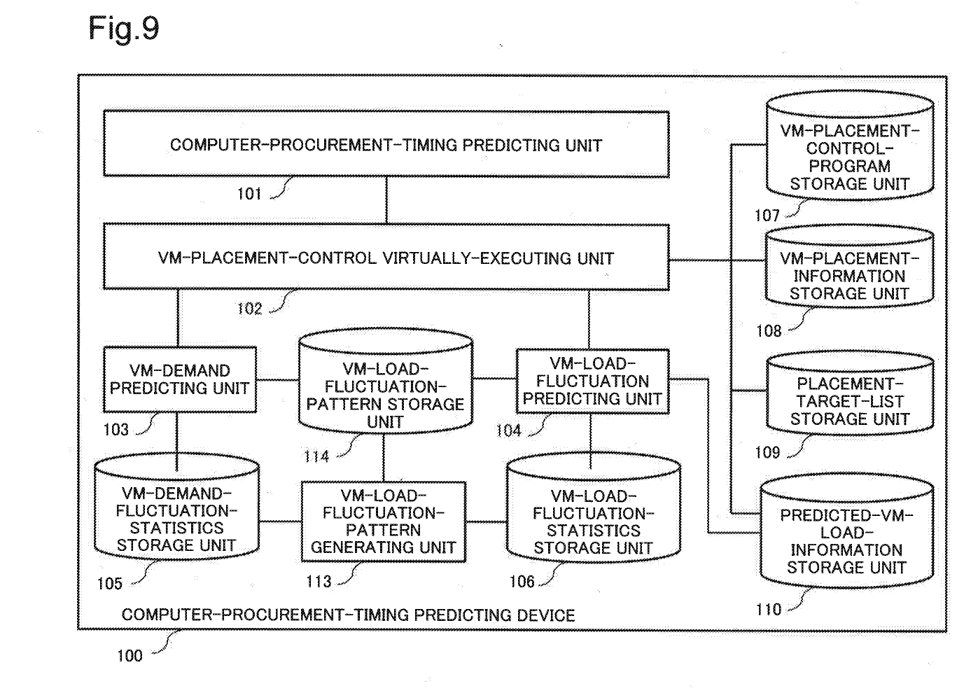

FIG. 9 is a block diagram of a computer-procurement-timing predicting device 100 according to a third example embodiment of the present invention. In comparison with the computer-procurement-timing predicting device 100 according to the first example embodiment, the computer-procurement-timing predicting device 100 in the present example embodiment further includes a VM-load-fluctuation-pattern generating unit 113, and a VM-load-fluctuation-pattern storage unit 114. The computer-procurement-timing predicting device 100 in the present example embodiment divides the VMs into groups on a predetermined criterion, and predicts a demand and a load fluctuation for each group.

### [Operation]

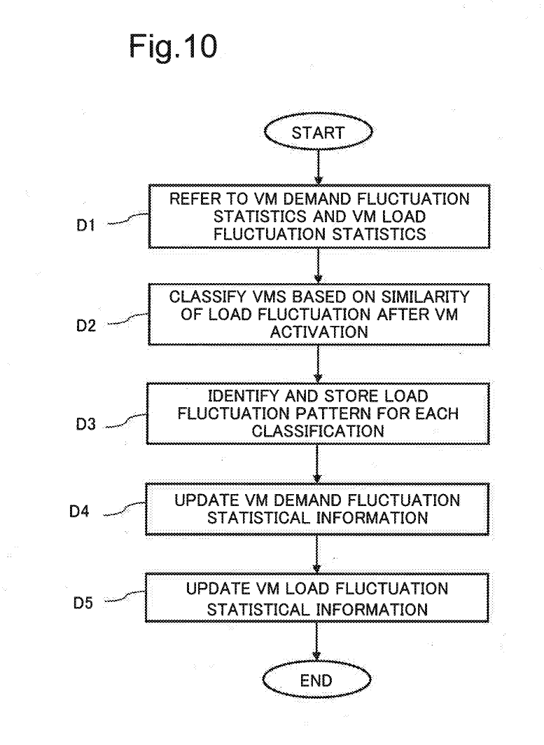

FIG. 10 is a flowchart of an operation of the VM-load-fluctuation-pattern generating unit 113. The VM-load-fluctuation-pattern generating unit 113 is activated by the computer-procurement-timing predicting unit 101 at step A1 in FIG. 4, for example.

Initially, the VM-load-fluctuation-pattern generating unit 113 refers to the VM-demand-fluctuation-statistics storage unit 105 and the VM-load-fluctuation-statistics storage unit 106 (step D1). The VM-load-fluctuation-pattern generating unit 113 identifies a pattern with which a load on an activated VM fluctuates (steps D2 and D3). The VM-load-fluctuation-pattern generating unit 113 may use, for example, an attribute of each activated VM to classify the VMs into groups, and may estimate a transition of a loaded state for each of the groups. Here, the attribute of each VM is, for example, an application purpose, a user, and a startup application program. The attribute of each VM is obtained from, for example, the VM-placement-information storage unit 108. The VM that is newly generated is estimated by the VM-demand predicting unit 103, for example, as mentioned above.

Moreover, the VM-load-fluctuation-pattern generating unit 113 may classify the VMs by using information, from the load fluctuation information, on a number of times or a frequency at which a load on each VM reaches a particular state.

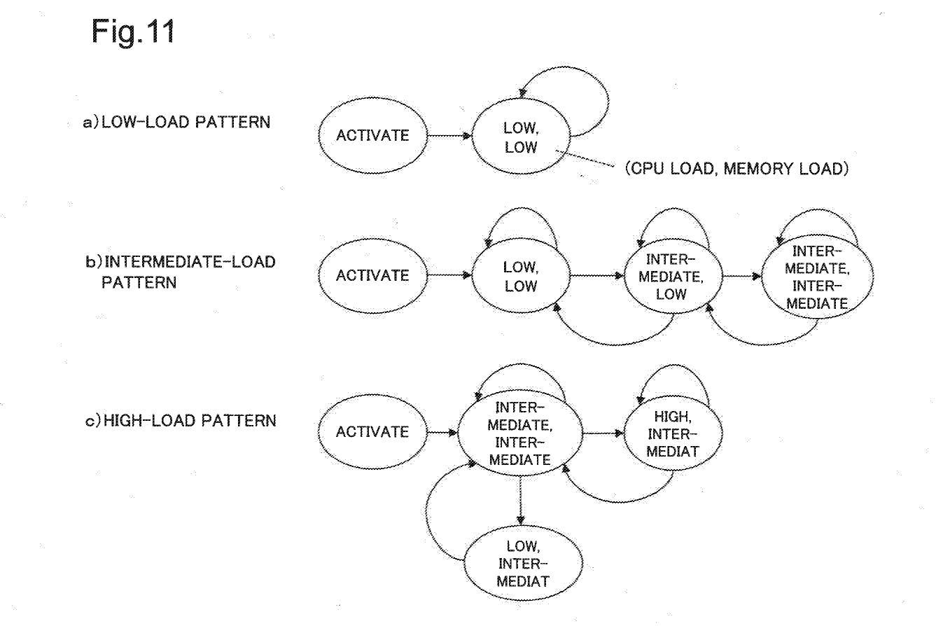

FIG. 11 illustrates an example of a load fluctuation pattern and a model that represents its state transition. Each load fluctuation pattern illustrated in FIG. 11 expresses how a loaded state transitions after the activation of the VM. For example, a low-load pattern at a) indicates that both of the CPU and the memory remain in a low-load state and do not transition after the activation of the VM. On the other hand, an intermediate-load pattern at b) indicates that the loaded state transitions among three states, namely, the state (low, low), the state (intermediate, low), and the state (intermediate, intermediate). The VM-load-fluctuation-pattern generating unit 113 may write a transition of a load fluctuation state of each VM for each Δt, from the VM load fluctuation statistics, for example, into a state column. With a number of the states (low, low) included in the state column, the VM-load-fluctuation-pattern generating unit 113 may classify the VMs into groups, and may estimate a state transition for each of the groups. For example, the VM-load-fluctuation-pattern generating unit 113 classifies the VMs as the low-load pattern when almost all the loaded states are the states (low, low), the high-load pattern when the states (low, low) are few in number, and the intermediate-load pattern otherwise. The VM-load-fluctuation-pattern generating unit 113 generates a state transition model for each of these groups, and regards this state transition model as a load pattern. The VM-load-fluctuation-pattern generating unit 113 stores the generated load pattern in the VM-load-fluctuation-pattern storage unit 114.

Next, the VM-load-fluctuation-pattern generating unit 113 adds information on the pattern to VM demand fluctuation statistical information to update the VM demand fluctuation statistical information (step D4). In other words, the VM-load-fluctuation-pattern generating unit 113 records, in a generation record of each VM, which load pattern the generated VM takes. This means to record, in the generation record of each VM, which group the generated VM belongs to.

Further, the VM-load-fluctuation-pattern generating unit 113 also adds the information on the pattern to VM load fluctuation statistical information to update the VM load fluctuation statistical information (step D5). In other words, the VM-load-fluctuation-pattern generating unit 113 records, in a load fluctuation record of each VM, which load pattern the VM in this load fluctuation record takes. This means to record, in the load fluctuation record of each VM, which group the VM in this load fluctuation record belongs to.

When being activated subsequently, the VM-demand predicting unit 103 divides or compiles the VM demand fluctuation statistics stored in the VM-demand-fluctuation-statistics storage unit 105, for each load fluctuation pattern. The VM-demand predicting unit 103 then predicts a demand, for each load fluctuation pattern, in the flow illustrated in FIG. 5, and adds the predicted demand to the placement target list. In other words, the VM-demand predicting unit 103 executes the flow illustrated in FIG. 5, based on the VM demand fluctuation statistics divided or compiled for each VM group.

Similarly, the VM-load-fluctuation predicting unit 104 divides or compiles the VM load fluctuation statistics stored in the VM-load-fluctuation-statistics storage unit 106, for each load fluctuation pattern. The VM-load-fluctuation predicting unit 104 then predicts a loaded state of the VM after Δt, for each load fluctuation pattern, in the flow illustrated in FIG. 6, and records the predicted loaded state. In other words, the VM-load-fluctuation predicting unit 104 executes the flow illustrated in FIG. 6, based on the VM load fluctuation statistics divided or compiled for each VM group.

### [Effects]

The computer-procurement-timing predicting device 100 in the present example embodiment can predict a VM host procurement timing more properly in a cloud system used by a plurality of users who use the VM in different utilization styles with different frequencies, by considering differences in user or load. This is because the VM-load-fluctuation-pattern generating unit 113 classifies VMs into groups, based on an attribute or on how a load fluctuation state transitions, and generates a load fluctuation pattern for each of the groups. This is also because the VM-demand predicting unit 103 and the VM-load-fluctuation predicting unit 104 then predict a demand and a load fluctuation for each load fluctuation pattern of each group.

### Fourth Example Embodiment

### [Configuration]

The VM generated in the cloud system is utilized by a user for a certain period, and is discarded when it becomes unnecessary. The discarded VM is eliminated from the placement target. By virtually executing the VM placement control in consideration of a number of discarded VMs as well, a computer-procurement-timing predicting device 100 can predict the server procurement timing more accurately.

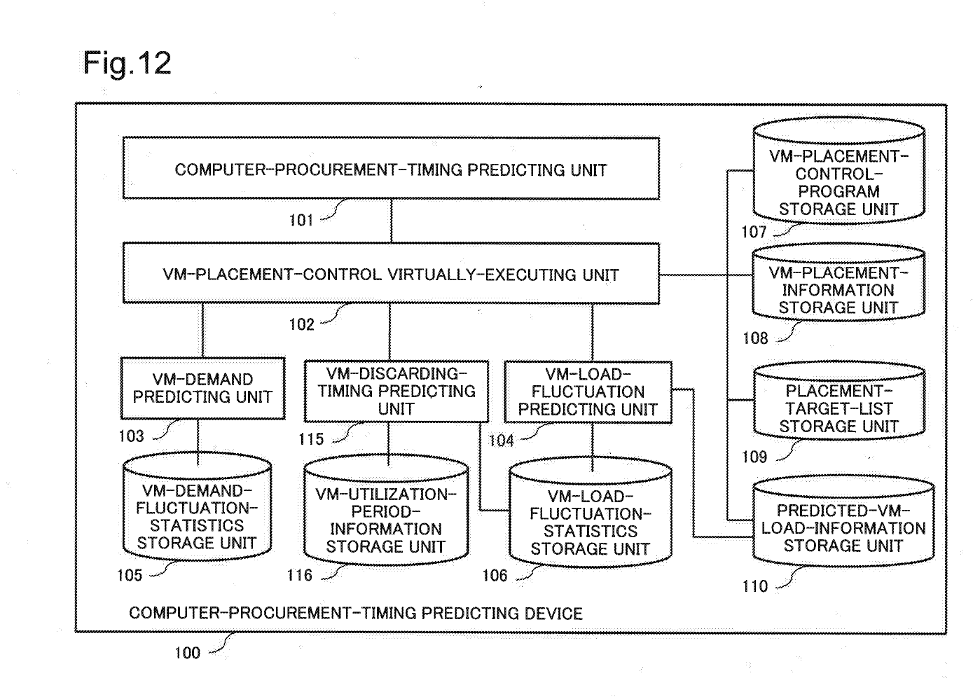

FIG. 12 is a block diagram of a computer-procurement-timing predicting device 100 according to a fourth example embodiment of the present invention. In comparison with the computer-procurement-timing predicting device 100 according to the first example embodiment, the computer-procurement-timing predicting device 100 in the present example embodiment further includes a VM-discarding-timing predicting unit 115 and a VM-utilization-period-information storage unit 116.

### [Operation]

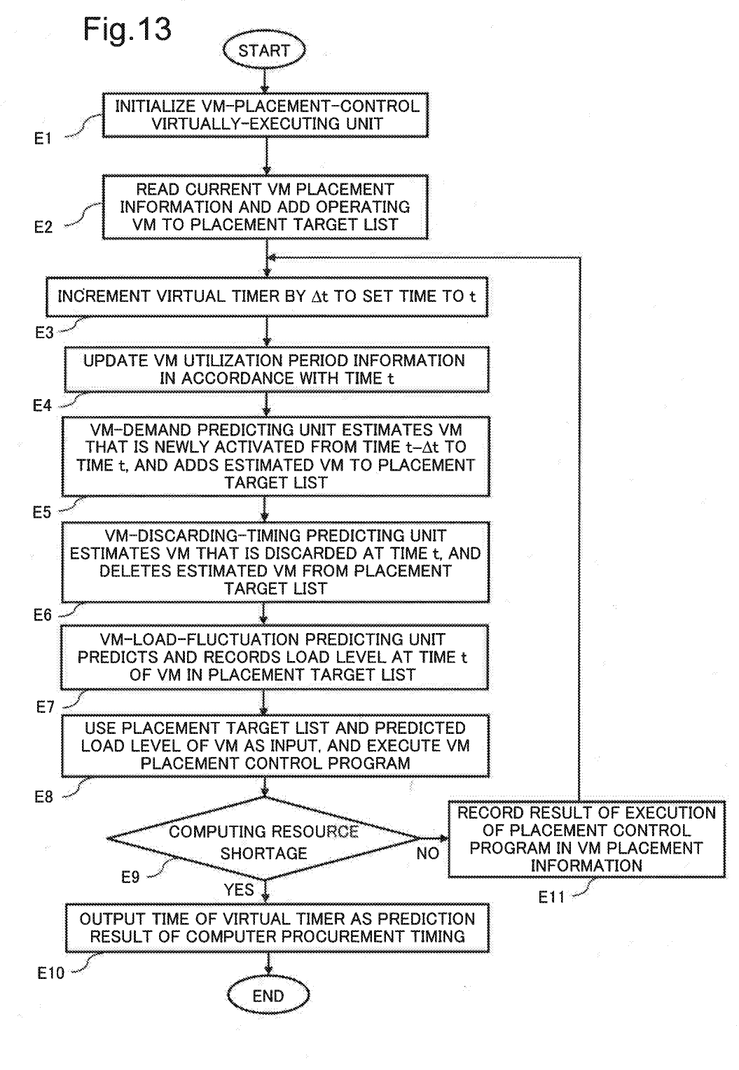

FIG. 13 is a flowchart of a whole operation of the computer-procurement-timing predicting device 100 according to the present example embodiment.

Initially, the computer-procurement-timing predicting unit 101 sets the VM-placement-control virtually-executing unit 102 to an initial state (step El). Next, the VM-placement-control virtually-executing unit 102 refers to the VM-placement-information storage unit 108 to refer to the current VM placement information. The VM-placement-control virtually-executing unit 102 then extracts the VM that is a placement target, and records the extracted VM in the placement target list in the placement-target-list storage unit 109 (step E2). The VM-placement-control virtually-executing unit 102 increments a time of the virtual timer by Δt to set the virtual time to t, in order to virtually execute the VM placement control (step E3).

Next, the VM-placement-control virtually-executing unit 102 updates a time reached after the generation of each VM, recorded in the VM-utilization-period-information storage unit 116, in accordance with the updated time t (step E4). Next, the VM-placement-control virtually-executing unit 102 calls up the VM-demand predicting unit 103. The VM-demand predicting unit 103 estimates the number of the VMs that are newly activated from the time t−Δt to the time t, and adds the estimated number to the placement target list (step E5).

Further, the VM-placement-control virtually-executing unit 102 calls up the VM-discarding-timing predicting unit 115. The VM-discarding-timing predicting unit 115 refers to the VM-utilization-period-information storage unit 116 to estimate the VM that is discarded from the time t−Δt to the time t, and deletes the estimated VM from the placement target list (step E6). Here, the VM-discarding-timing predicting unit 115 predicts a VM discarding timing based on a specific rule. For example, the VM-discarding-timing predicting unit 115 may use a rule that the VM for which two years have elapsed from its generation should be discarded. Moreover, the VM-discarding-timing predicting unit 115 may estimate the discarding timing by using a combination of such a rule and VM load fluctuation information. For example, the VM-discarding-timing predicting unit 115 may use a rule that the VM for which one year has elapsed from its generation, and which exhibits almost no load fluctuation during a most recent month, should be discarded.

In the subsequent steps (E7 to E11), the computer-procurement-timing predicting device 100 performs the same operation as that in the steps (A5 to A9) in the flowchart illustrated in FIG. 4.

### [Effects]

The computer-procurement-timing predicting device 100 in the present example embodiment can adequately predict the VM host procurement timing by considering a status of increase or decrease in VM, which is a placement target. This is because the VM-discarding-timing predicting unit 115 predicts the number of the VMs that are discarded, subtracts that number from the number of the VMs in the placement target list, and then virtually executes the VM placement control.

### Fifth Example Embodiment

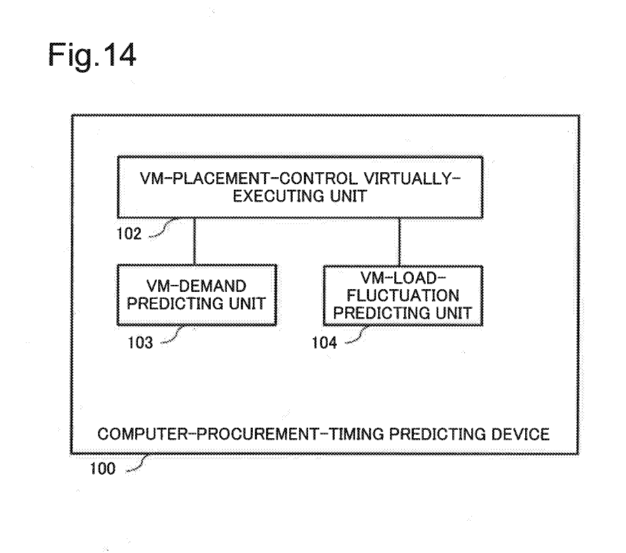

FIG. 14 is a block diagram of a computer-procurement-timing predicting device 100 according to a fifth example embodiment of the present invention. The computer-procurement-timing predicting device 100 includes a VM-demand predicting unit 103, a VM-load-fluctuation predicting unit 104, and a VM-placement-control virtually-executing unit 102.

The VM-demand predicting unit 103 calculates a predicted value of a number of the VMs that are generated from the time t−Δt to the time t, based on the demand fluctuation statistics. The demand fluctuation statistics indicate a generation status of the virtual machine to be deployed on a plurality of computers. The VM-demand predicting unit 103 then adds the calculated predicted value to the placement target list that registers a number of the VMs deployed on the computers at the time t−Δt.

The VM-load-fluctuation predicting unit 104 outputs a predicted load at the time t of each of the VMs, the number of which is registered in the placement target list, based on the load fluctuation statistics that indicate a load fluctuation of the VM on the plurality of computers. Based on the predicted load, the VM-placement-control virtually-executing unit 102 virtually places the VMs, the number of which is registered in the placement target list, on the plurality of computers at the time t, and determines whether or not a resource shortage occurs.

The computer-procurement-timing predicting device 100 in the present example embodiment can properly predict the timing at which an additional VM host is required, by considering the demand fluctuation and the load fluctuation of the VM, and the algorithm that replaces the VM. This is because the VM-demand predicting unit 103 predicts the VM that will be added, the VM-load-fluctuation predicting unit 104 predicts a load fluctuation of the VM during operation and a load fluctuation of the VM that is newly added, and the VM-placement-control virtually-executing unit 102 uses the VM re-placement algorithm to virtually execute the VM placement control.

Although the invention in the present application has been described with reference to the example embodiments, the present invention is not limited to the example embodiments described above. To the configuration and detail of the present invention, various modifications that a person having ordinary skill in the art can understand may be applied within the scope of the present invention.

This application claims priority based on Japanese Patent Application No. 2015-094674, filed on May 7, 2015, the disclosed contents of which are hereby incorporated by reference in their entirety.

### REFERENCE SIGNS LIST

100 Computer-procurement-timing predicting device
101 Computer-procurement-timing predicting unit
102 VM-placement-control virtually-executing unit
103 VM-demand predicting unit
104 VM-load-fluctuation predicting unit
105 VM-demand-fluctuation-statistics storage unit
106 VM-load-fluctuation-statistics storage unit
107 VM-placement-control-program storage unit
108 VM-placement-information storage unit
109 Placement-target-list storage unit
110 Predicted-VM-load-information storage unit
111 VM-placement-control-information obtaining unit
114 VM-load-fluctuation-pattern storage unit
115 VM-discarding-timing predicting unit
116 VM-utilization-period-information storage unit
200 Managing device
201 VM-placement-control-program-in-use storage unit
202 Current-VM-placement-information storage unit
203 VM-placement-control executing unit
300 Computer-procurement-timing predicting system
1031 Demand-fluctuation predicting unit
1032 Demand-model-parameter estimating unit
1033 VM-demand-fluctuation-model storage unit
1034 VM-demand-fluctuation-model-parameter storage unit
1041 Load-fluctuation predicting unit
1042 Load-model-parameter estimating unit
1043 VM-load-fluctuation-model storage unit
1044 VM-load-fluctuation-model-parameter storage unit

What is claimed is:

1. A computer-procurement-timing predicting device comprising:
a VM-demand predicting unit which calculates, based on demand fluctuation statistics which indicate a generation status of a virtual machine (hereinafter, a VM) to be deployed on a plurality of computers, a predicted value of a number of the VMs which are generated from a time t−Δt to a time t, and adds the predicted value to a placement target list which registers a number of the VMs deployed on the computers at the time t−Δt;
a VM-load-fluctuation predicting unit which outputs, based on load fluctuation statistics which indicate a load fluctuation of the VM on the plurality of the computers, a predicted load at the time t of each of the VMs, the number of which is registered in the placement target list; and
a VM-placement-control virtually-executing unit which virtually places, based on the predicted load, the VMs, the number of which is registered in the placement target list, on the plurality of the computers at the time t, and determines whether or not a resource shortage occurs.

2. The computer-procurement-timing predicting device according to claim 1, wherein, based on a transition probability between every two of states in a discrete-time Markov chain model which regards a set of load indexes as a state, the set of the load indexes being M discrete numerical values (where M is a plural number) each representing a load status for each of M resources in the computers, the transition probability being calculated from the load fluctuation statistics, and the state of each of the VMs at the time t−Δt, the VM-load-fluctuation predicting unit estimates and outputs the state at the time t.

3. The computer-procurement-timing predicting device according to claim 1, wherein the VM-demand predicting unit calculates the predicted value of the number of the VMs which are generated, based on an estimated value of an average arrival rate in a Poisson arrival process, the estimated value being calculated from the demand fluctuation statistics.

4. The computer-procurement-timing predicting device according to claim 1, further comprising:
a VM-placement-control-information obtaining unit which acquires a number of the VMs deployed on the plurality of the computers, from a managing device which determines placement of the VM for the plurality of the computers, registers the acquired number in the placement target list, and acquires, from the managing device, placement control information for determining an algorithm which virtually places the VM on the plurality of the computers, wherein
the VM-placement-control virtually-executing unit uses the algorithm determined by the acquired placement control information, and virtually places the VM registered in the placement target list, on the plurality of the computers.

5. The computer-procurement-timing predicting device according to claim 1, wherein
the VM-demand predicting unit compiles data in the demand fluctuation statistics to obtain data for each of groups of the VMs, classified on a predetermined criterion, and, based on the data for the groups, predicts a number of VMs which are generated for each of the groups, and the VM-load-fluctuation predicting unit compiles data in the load fluctuation statistics to obtain data for each of the groups, and, based on the data for the groups, estimates a load fluctuation of the VM in the groups, on a group-by-group basis.

6. The computer-procurement-timing predicting device according to claim 1, further comprising:
a VM-discarding-timing predicting unit which subtracts a number of the VMs discarded from the time t−Δt to the time t, based on a predetermined rule, from the placement target list, wherein
the VM-placement-control virtually-executing unit repeatedly activates the VM-demand predicting unit, the VM-load-fluctuation predicting unit, and the VM-discarding-timing predicting unit while incrementing a time by Δt, and detects and outputs a time at which a resource shortage is determined to occur when the VM registered in the placement target list is placed on the plurality of the computers.

7. A computer-procurement-timing predicting method comprising:
calculating, based on demand fluctuation statistics which indicate a generation status of a virtual machine (hereinafter, a VM) to be deployed on a plurality of computers, a predicted value of a number of the VMs which are generated from a time t−Δt to a time t, and adding the predicted value to a placement target list which registers a number of the VMs deployed on the computers at the time t−Δt;
outputting, based on load fluctuation statistics which indicate a load fluctuation of the VM on the plurality of the computers, a predicted load at the time t of each of the VMs, the number of which is registered in the placement target list; and
virtually placing, based on the predicted load, the VMs, the number of which is registered in the placement target list, on the plurality of the computers at the time t, and determining whether or not a resource shortage occurs.

8. The computer-procurement-timing predicting method according to claim 7, further comprising: based on a transition probability between every two of states in a discrete-time Markov chain model which regards a set of load indexes as a state, the set of the load indexes being M discrete numerical values (where M is a plural number) each representing a load status for each of M resources in the computers, the transition probability being calculated from the load fluctuation statistics, and the state of each of the VMs at the time t−Δt, estimating and outputting the state at the time t.

9. The computer-procurement-timing predicting method according to claim 7, further comprising: calculating the predicted value of the number of the VMs which are generated, based on an estimated value of an average arrival rate in a Poisson arrival process, the estimated value being calculated from the demand fluctuation statistics.

10. A non-transitory computer readable recording medium which records a program which causes a computer to execute the computer-procurement-timing predicting method according to claims 7.

11. The computer-procurement-timing predicting device according to claim 2, wherein the VM-demand predicting unit calculates the predicted value of the number of the VMs which are generated, based on an estimated value of an average arrival rate in a Poisson arrival process, the estimated value being calculated from the demand fluctuation statistics.

12. The computer-procurement-timing predicting device according to claim 2, further comprising:
a VM-placement-control-information obtaining unit which acquires a number of the VMs deployed on the plurality of the computers, from a managing device which determines placement of the VM for the plurality of the computers, registers the acquired number in the placement target list, and acquires, from the managing device, placement control information for determining an algorithm which virtually places the VM on the plurality of the computers, wherein
the VM-placement-control virtually-executing unit uses the algorithm determined by the acquired placement control information, and virtually places the VM registered in the placement target list, on the plurality of the computers.

13. The computer-procurement-timing predicting device according to claim 3, further comprising:
a VM-placement-control-information obtaining unit which acquires a number of the VMs deployed on the plurality of the computers, from a managing device which determines placement of the VM for the plurality of the computers, registers the acquired number in the placement target list, and acquires, from the managing device, placement control information for determining an algorithm which virtually places the VM on the plurality of the computers, wherein
the VM-placement-control virtually-executing unit uses the algorithm determined by the acquired placement control information, and virtually places the VM registered in the placement target list, on the plurality of the computers.

14. The computer-procurement-timing predicting device according to claim 2, wherein
the VM-demand predicting unit compiles data in the demand fluctuation statistics to obtain data for each of groups of the VMs, classified on a predetermined criterion, and, based on the data for the groups, predicts a number of VMs which are generated for each of the groups, and
the VM-load-fluctuation predicting unit compiles data in the load fluctuation statistics to obtain data for each of the groups, and, based on the data for the groups, estimates a load fluctuation of the VM in the groups, on a group-by-group basis.

15. The computer-procurement-timing predicting device according to claim 3, wherein
the VM-demand predicting unit compiles data in the demand fluctuation statistics to obtain data for each of groups of the VMs, classified on a predetermined criterion, and, based on the data for the groups, predicts a number of VMs which are generated for each of the groups, and
the VM-load-fluctuation predicting unit compiles data in the load fluctuation statistics to obtain data for each of the groups, and, based on the data for the groups, estimates a load fluctuation of the VM in the groups, on a group-by-group basis.

16. The computer-procurement-timing predicting device according to claim 4, wherein
the VM-demand predicting unit compiles data in the demand fluctuation statistics to obtain data for each of groups of the VMs, classified on a predetermined criterion, and, based on the data for the groups, predicts a number of VMs which are generated for each of the groups, and
the VM-load-fluctuation predicting unit compiles data in the load fluctuation statistics to obtain data for each of the groups, and, based on the data for the groups, estimates a load fluctuation of the VM in the groups, on a group-by-group basis.

17. The computer-procurement-timing predicting device according to claim 2, further comprising:
a VM-discarding-timing predicting unit which subtracts a number of the VMs discarded from the time t−Δt to the time t, based on a predetermined rule, from the placement target list, wherein
the VM-placement-control virtually-executing unit repeatedly activates the VM-demand predicting unit, the VM-load-fluctuation predicting unit, and the VM-discarding-timing predicting unit while incrementing a time by Δt, and detects and outputs a time at which a resource shortage is determined to occur when the VM registered in the placement target list is placed on the plurality of the computers.

18. The computer-procurement-timing predicting device according to claim 3, further comprising:
a VM-discarding-timing predicting unit which subtracts a number of the VMs discarded from the time t−Δt to the time t, based on a predetermined rule, from the placement target list, wherein
the VM-placement-control virtually-executing unit repeatedly activates the VM-demand predicting unit, the VM-load-fluctuation predicting unit, and the VM-discarding-timing predicting unit while incrementing a time by Δt, and detects and outputs a time at which a resource shortage is determined to occur when the VM registered in the placement target list is placed on the plurality of the computers.

19. The computer-procurement-timing predicting device according to claim 4, further comprising:
a VM-discarding-timing predicting unit which subtracts a number of the VMs discarded from the time t−Δt to the time t, based on a predetermined rule, from the placement target list, wherein
the VM-placement-control virtually-executing unit repeatedly activates the VM-demand predicting unit, the VM-load-fluctuation predicting unit, and the VM-discarding-timing predicting unit while incrementing a time by Δt, and detects and outputs a time at which a resource shortage is determined to occur when the VM registered in the placement target list is placed on the plurality of the computers.

20. The computer-procurement-timing predicting device according to claim 5, further comprising:
a VM-discarding-timing predicting unit which subtracts a number of the VMs discarded from the time t−Δt to the time t, based on a predetermined rule, from the placement target list, wherein
the VM-placement-control virtually-executing unit repeatedly activates the VM-demand predicting unit, the VM-load-fluctuation predicting unit, and the VM-discarding-timing predicting unit while incrementing a time by Δt, and detects and outputs a time at which a resource shortage is determined to occur when the VM registered in the placement target list is placed on the plurality of the computers.
